(19) United States
(12) Patent Application Publication
(10) Pub. No.: US 2007/0221342 A1
(43) Pub. Date: Sep. 27, 2007

(54) Woven shutter slat

(76) Inventor: Chin-Fu Chen, Taichung City (TW)

Correspondence Address: BIRCH STEWART KOLASCH & BIRCH, PO BOX 747, FALLS CHURCH, VA, 22040-0747, US

(21) Appl. No.: 11/386,009

(22) Filed: Mar. 22, 2006

(51) Int. Cl. E06B 3/12

(52) U.S. Cl. 160/236; 160/330

(57) ABSTRACT

A woven shutter slat is made from foamed PVC at a selected width and woven by a plurality of longitudinal and latitudinal materials in a stagger manner. The slat is coated with a layer of ink on the peripheral surface. The ink layer is embossed to form desired colors and patterns, and generate a glossy appearance, thereby to provide colorful and three-dimensional visual effect.

### FIELD OF THE INVENTION

The present invention relates to a shutter slat and particularly to a woven shutter slat that is printed with desired colors and patterns and has three-dimensional woven traces mimic the look of bamboo or other natural materials.

### BACKGROUND OF THE INVENTION

The conventional window coverings generally can be divided into drapes made from fabrics and shutters made of plastic blades. The drapes are woven from fibers and have three-dimensional surfaces. With golden and colored fibers, a colorful visual effect can be achieved. The fabrics also can be dyed or printed with appealing patterns. Hence aside from blocking light, they also provide decorative effect and are useful in interior design. They are especially desirable for large casement windows in a large space to generate lofty and luxuriant feeling. However, people's preference and taste for household decoration vary greatly. Besides matching the material and surface color of the drapes with the decoration of rooms, installation location and water-proof function also are important factors to be considered. For instance, the shutters installed in the kitchen or bathroom have to be water-proof. For the Japanese room, the slats of the shutter are preferably made from woods or bamboos, or synthetic plastics with the surface mimic wooden traces. In the present market, the shutters and drapes woven from natural materials are quite popular. The slats formed with desired traces and colors can enhance the product added-value and make the product more competitive in the market place.

### SUMMARY OF THE INVENTION

Therefore the present invention aims to provide a woven shutter slat with three-dimensional effect to generate a glossy look and embossed with colored patterns.

The primary object of the present invention is to provide a woven shutter slat made from foamed Polyvinyl chloride (PVC). It includes slats of a desired width woven in a stagger manner by a plurality of longitudinal material and latitudinal materials. Each of the slats is coated with a layer of ink on the peripheral surface. The ink layer is colored and embossed with selected patterns to produce a glossy look. Thus it provides versatile and colorful patterns and three-dimensional visual effect.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a plane view of an embodiment of the invention.

FIG. 2 is a sectional view of an embodiment of the invention.

FIG. 3 is a perspective view of the invention in a use condition.

### DETAILED DESCRIPTION OF THE PREFERRED EMBODIMENT

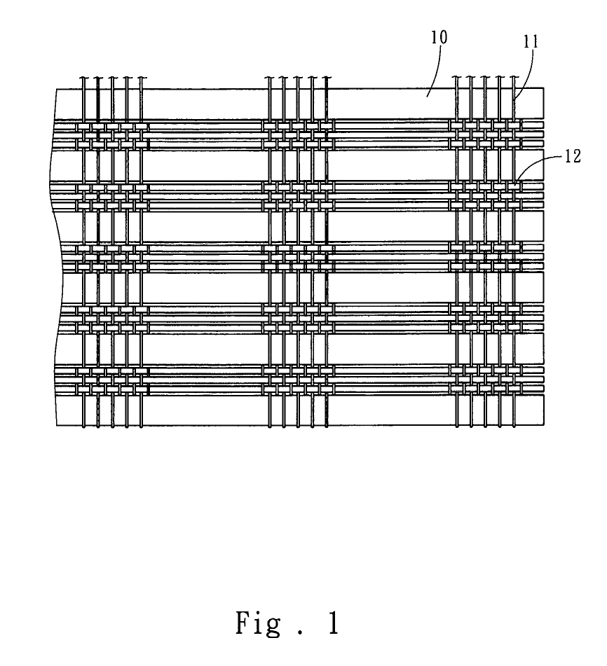

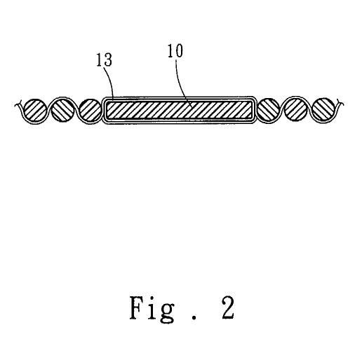

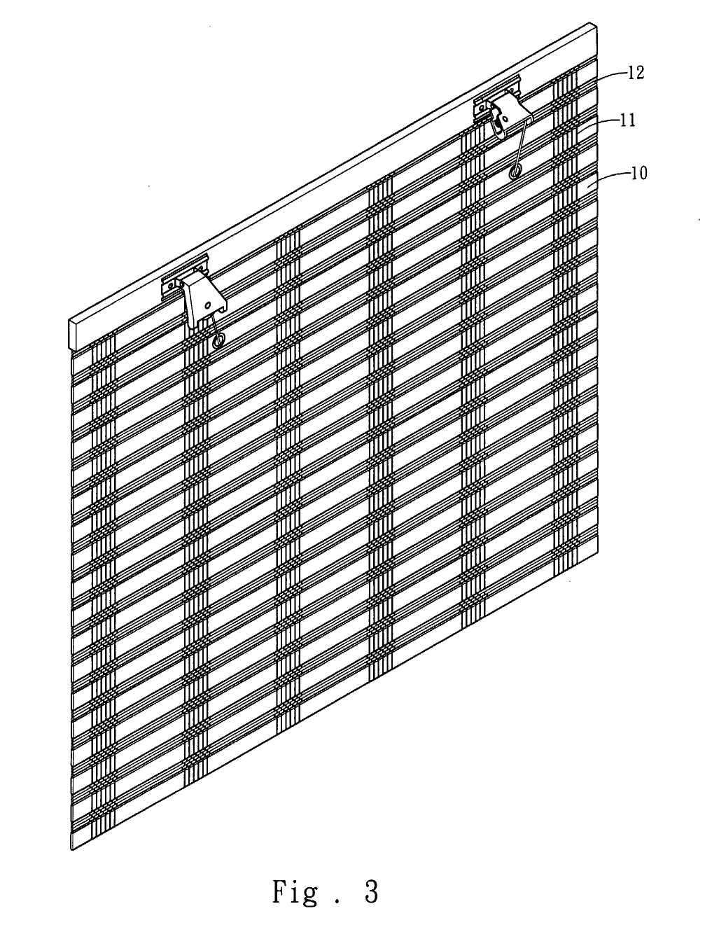

Please refer to FIGS. 1, 2 and 3, the woven shutter slat according to the invention is made from foamed PVC and includes a slat 10 formed in a desired size and is woven by a plurality of longitudinal materials 11 and latitudinal materials 12. The surface of the slat 10 is coated by a layer of ink 13 which is formed in varying colors and patterns by embossing. The resulting slat has a glossy appearance and three dimensional weaving traces. It has a glittered look and provides versatile colors and patterns.

Prototypes of the invention have been made and tested, and proved achieving the functions and benefits previously discussed. It offers a significant improvement over the conventional shutter slat.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A woven shutter slat made from foamed Polyvinyl chloride (PVC) comprising slats of a selected width worn by a plurality of longitudinal materials and latitudinal materials in an stagger manner, each of the slats being coated with a layer of ink on the peripheral surface, the ink layer being embossed to form desired colors and patterns and generate a glossy appearance.
